(19) United States
(12) Patent Application Publication
(10) Pub. No.: US 2007/0005738 A1
(43) Pub. Date: Jan. 4, 2007

(54) Automated remote scanning of a network for managed and unmanaged devices

(75) Inventors: Karri Alexion-Tiernan, Fall City, WA (US); Sanjiv Sharma, Bellevue, WA (US); Venugopal Sankarapillai, Issaquah, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/170,555

(22) Filed: Jun. 29, 2005

(51) Int. Cl. G06F 15/173

(52) U.S. Cl. 709/223

(57) ABSTRACT

A set of possible device IP addresses is determined. The list of IP devices is pinged and split into responsive and unresponsive devices. The responsive devices are scanned to determine which provide administrative access rights. Of those devices that provide administrative access, the devices are further separated into managed and unmanaged devices. The unmanaged devices are scanned for specific software and services, including if those software and services are the most current or up-to-date versions. An administrator may then be presented with a network report based on the scan at the level of detail desired by the user.

### BACKGROUND

A typical computer network may have hundreds of computers attached to it. These computers may be of a variety of types, run a variety of operating systems, and connect to the network in a variety of ways. The task of maintaining and keeping the computers up-to-date with the latest software and security patches can be a very difficult and time consuming task.

Solutions to this problem include the use of management software on the computers in the network. Each computer attached to the network runs a management agent, for example. The management agent runs as a background process on a device and is responsible for scanning the device for missing software updates, retrieving/requesting the updates from the management computer and applying the latest software and security updates to the device.

However, some networks can be very large and may include many devices. Some legacy devices may not have management software installed, and on other devices the installation of management software may have been overlooked or even inadvertently disabled. Other users may have connected unmanaged devices to the network without the permission of the administrator. Further, management software may not be as reliable as an administrator believes. Each of these scenarios introduces a risk to the network.

### SUMMARY

A set of possible device Internet Protocol (IP) addresses is determined from various sources. The IP addresses are pinged to locate devices. The located devices are scanned remotely to determine which devices provide administrative access rights. Of those devices that provide administrative access, the devices are further separated into managed and unmanaged devices. The unmanaged devices are scanned for specific software and services, including if those software and services are the most current or up-to-date versions. An administrator may then be presented with a consolidated network report describing the devices attached to the network at the level of detail desired by the administrator.

### BRIEF DESCRIPTION OF THE DRAWINGS

FIG. 1 is an illustration of an exemplary network of managed and unmanaged devices in accordance with the present invention;

FIG. 2 is a block diagram illustrating an exemplary method of scanning a network for managed and unmanaged devices in accordance with the present invention;

FIG. 3 is a block diagram illustrating an exemplary system for scanning a network for managed and unmanaged devices in accordance with the present invention; and

FIG. 4 is a block diagram showing an exemplary computing environment in which aspects of the invention may be implemented.

### DETAILED DESCRIPTION

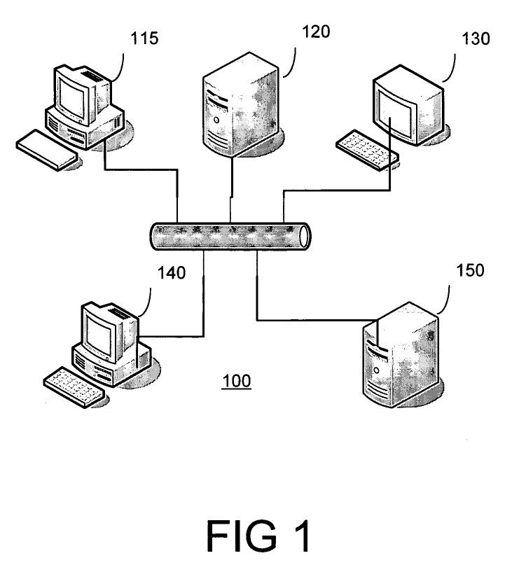

FIG. 1 is an illustration of an exemplary network 100 of managed and unmanaged devices in accordance with the present invention. The network 100 comprises devices 115, 120, 130, 140, and 150. Each device may be one of a variety of computer types, including laptop, desktop, and server computers. Further, each device may be running one or more different operating systems and applications. While there are only five devices shown in the network 100, it is for illustrative purposes only and is not meant to limit the invention to networks of five devices. There is no limit to the number of devices that may be supported by the invention.

The devices connected to the network 100 may be both managed and unmanaged. A managed device is a device that has management agent software installed that ensures that the device remains up-to-date on all current software and operating system updates. An example of such software is Systems Management Server (“SMS”) from Microsoft Corporation. In SMS, each managed device runs an SMS agent that communicates with an SMS server. When an update is made available for an operating system or software, the SMS server communicates the availability of the update to the SMS agents. The SMS agents may then scan the local device to determine if the update is relevant to their device and if so, download the update from the server. For managed devices an administrator of the network can be reasonably assured that the software on those devices will be up-to-date. In contrast, for unmanaged devices an administrator must take steps to ensure that the device remain up-to-date.

Further, the administrator may not even know about the existence of some of the unmanaged devices, ensuring that the unmanaged devices remain behind on available updates.

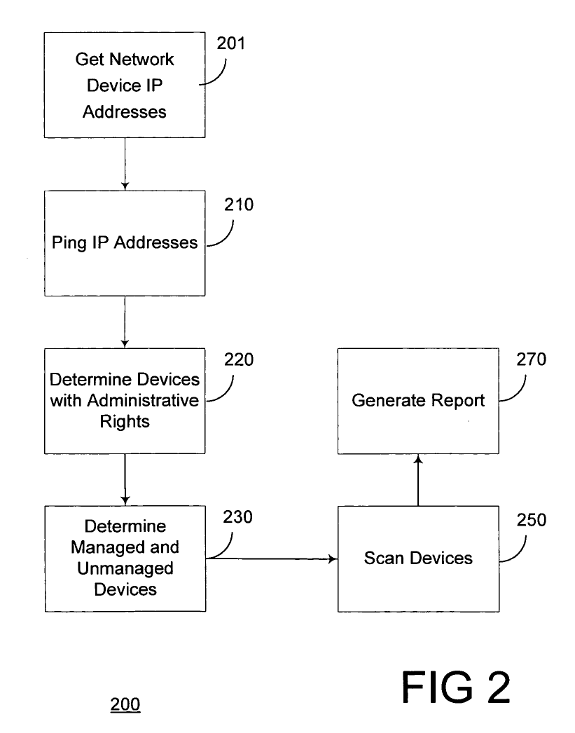

In order to determine what devices are connected to the administrator's network, the administrator may execute a network scan in accordance with the present invention. The network scan may be executed from one or more devices connected to the network, such as devices 115, 120, 130, 140, and 150, for example. This network scan is described in detail with respect to FIG. 2.

FIG. 2 is a block diagram illustrating an exemplary method of scanning a network for managed and unmanaged devices in accordance with the present invention. A set of possible device IP addresses is determined. The IP addresses are pinged and a list is generated of responsive devices and unresponsive devices. The responsive devices are scanned to determine which devices provide administrative access rights to the network scan. Of those devices that provide administrative access, the devices are further separated into managed and unmanaged devices. The unmanaged devices are scanned for specific software and services, including if those software and services are the most current or up-to-date versions. A network administrator may then be presented with a network report at the level of detail desired.

At 201, the possible IP addresses for the network devices are retrieved. As described previously, the network scan is desirably ran from a computer or device connected to the network. If the device has an active network directory, the available IP addresses can be generated by first retrieving available subnets from the active directory. These subnets may be stored in a file, for example. From the available subnets, a list of all possible IP addresses belonging to those subnets can be easily generated. Any system, method or technique known in the art for generating IP addresses from subnets may be used.

However, in order to obtain the list of subnets from an active directory, the network scan should have read access to the active directory. For the cases where read access is unavailable, or as a supplement to the method described above, the scan may query the LDAP controller to find the domain of the device executing the current scan. This domain can then be used to obtain a list of available subnets from the domain controller. The list of IP addresses are universal in an active directory forest and hence querying a single controller is sufficient to retrieve all the IP addresses registered in the active directory throughout the network The possible IP address belonging to these subnets can be generated in a manner similar to that described above.

In addition, the administrator may also directly specify, in a text file for example, a list of IP addresses or subnets that the user may wish to scan. In some cases the administrator may know which devices exist on the network and can save time by specifying them directly. Any system, method, or technique known in the art for generating or retrieving available IP addresses on a network may be used.

At 210, the collected and generated IP addresses may be pinged to determine which IP addresses are active or correspond to a device attached to the network. For example, the device executing the network scan may send a small message to an IP address asking for a response. If no response is received after a predetermined timeout period, then the scan may assume that either there is no device at that IP address, or that the device at that IP address is unresponsive. If a response is received then the IP address may be added to a list of responsive IP addresses, for example. Unresponsive devices may be added to the unresponsive (unreachable) IP address list to be included later in a consolidated report.

Where a large number of IP addresses have been collected or generated, the IP addresses may be first divided into separate groups. Each group may comprise twenty IP addresses, for example. The script may then ping the various IP addresses in parallel by having separate threads or processes ping IP addresses from each separate group, for example.

At 220, the devices at the responsive IP addresses are checked for administrator rights. The devices may be checked by making a Windows Management Instrumentation (WMI) call to the remote device's system registry to read the computer name and network information. However, any system, method, or technique known in the art checking administration rights may be used. Because the device executing the network scan may need access to the device registries or may require knowledge of currently active processes, it may be desirable that the device have administrative access to those network devices. After determining which devices provide such access, the devices are separated into a list of devices providing administrative access rights and a list of devices that do not provide administrative access rights. Any system, method, or technique known in the art for determining if administrative access rights are provided may be used.

At 230, the devices that provide administrative access may be probed to determine if they are managed. As described previously, a device is managed if there are procedures for ensuring that the device is kept up-to-date with security patches or critical updates to both the operating system and certain applications, such as management software for example.

The presence of managing software on a particular device or computer can be checked by searching the system registry for a key or indicator that managing software or a managing agent is installed, for example. However, after detecting the presence of a registry entry, the device may be further probed to determine if the program matching the registry entry is currently active on the system. Because the presence of registry entry does not necessarily indicate if the managing agent is active, or that it has not been uninstalled, the registry entry may be checked against a list of active programs and processes on the device. Those devices providing administrative access that have both a registry entry and a managing agent running may be added to a list of managed devices. Those devices without a registry entry and corresponding active process may be added to a list of unmanaged devices. Any system, method, or technique in the art may be used for both remotely viewing the registry of a device and remotely viewing the active processes on a device.

At 250, the unmanaged devices that allow administrative access are desirably scanned for particular applications and updates. As described previously, an administrator may wish to determine which devices are unmanaged because those devices may not be up-to-date on security patches, or may pose other threats to the network. Accordingly, the unmanaged devices are scanned for particular software updates and particular applications. The unmanaged devices may be scanned by first searching the system registry for particular applications or updates, and then searching each device for any applications currently executing. Any system, method or technique known in the art may be used.

In addition to recording the updates, and applications that have been installed on an unmanaged device, there may be additional application specific information recorded. For example, the unmanaged devices may searched for instances of Virtual Server. Any device found to be executing Virtual Server may be recorded. However, it also may be desirable to learn the number of virtual guests associated with each virtual host found on the network. Accordingly, the scan desirably records and associates each discovered virtual guest with its virtual host on the network. Each virtual guest may be further scanned for whatever information the administrator may desire. Any system, method, or technique known in the art for identifying and scanning virtual guests may be used.

As described above, only the unmanaged devices found on the network are scanned. Generally, the managed devices are not scanned because the administrator presumably knows that these device are up-to-date with patches and what applications are running on them. However, if the user or administrator desires to scan the managed devices anyway, the user or administrator may specify that they be scanned in a configuration file, for example.

At 270, a report is generated with the results of the network scan. The report may be generated using the information collected during the network scan. Any system, method or technique known in the art for generating a report may be used.

The report may be generated at the specificity or level of detail as requested by the user or administrator, for example. The report may comprise a listing of all of the devices detected on the network, e.g., devices that responded to initial ping at 210. The report may also comprise a listing of each detected device separated into groups of devices that granted the network scan administrative access, and those device that did not. Because only devices that provided administrative access were further scanned for their managed or unmanaged status, an administrator may wish to know which devices were not scanned so that the administrator can determine how to proceed with respect to those devices.

The report may also comprise a listing of which devices are managed and unmanaged, and of the unmanaged devices, what is the status of those devices with regards to updates and applications installed on the devices. In addition, any application specific information that the user or administer may have requested can also be displayed in the report.

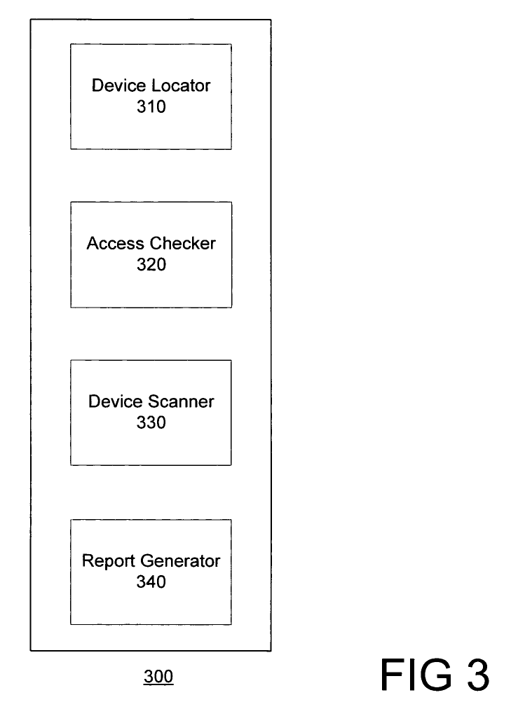

FIG. 3 is block diagram of an exemplary system for locating managed and unmanaged devices in a network in accordance with the present invention. The system includes several means, devices, software, and/or hardware for performing functions, including a device locator 310, an access checker 320, a device scanner 330, and a report generator 340.

The device locator 310 identifies the devices connected to the network. As described with respect to FIGS. 1 and 2, the network may comprise several devices. In order to facilitate the automatic scanning of the network, the devices on the network are first identified. In one embodiment, the device locator may first generate all possible network addresses in the network. These addresses may be generated from the available subnets existing on the network, for example. In another embodiment, these addresses may be provided by an administrator in a file, for example. Any system, method, or technique known in the art for determining available network addresses may be used.

The device locator 310, using the IP addresses, may then verify that these addresses correspond to an actual device. The device locator 310 may ping, or otherwise attempt to contact, a device at each IP address. If a device responds, then it is verified that there is a device at that address. If not, then the address may be removed from consideration. If there are a large number of addresses to contact, the list of addresses may be divided among several processes and pinged in parallel. The device locator 310 can be implemented using any suitable system, method or technique known in the art for identifying devices connected to a network. The device locator 310 can be implemented using software, hardware, or a combination of both.

The access checker 320 determines if the detected devices provide sufficient access rights for the network scan to perform an analysis. Because the network scan identifies managed and unmanaged devices, as well as collects details from each device regarding the software and operating systems executing at them, it is desirable that the network scan be provided administrative access to the detected devices. The access checker 320 can be any implemented using any suitable system, method or technique known in the art for determining the access rights granted by a device. The access checker 320 can be implemented using software, hardware, or a combination of both.

The device scanner 330 determines if the detected devices are current with respect to software and security updates. The device scanner 330 may scan each device that provides administrative access as determined by the access checker 320. Each device may be scanned by first checking the device registry for the presence of a management agent, such as SMS for example. Any entry in the registry for a management agent can be verified by checking it against a list of active processes on the device. Checking the active processes ensures that the management agent is actually running and managing the particular devices. Once the managed and unmanaged devices are determined, the unmanaged devices may be further scanned to determine what applications and software are installed on the machines. The unmanaged devices may be scanned for any relevant data as specified by an administrator. In addition, the managed devices may also be scanned, but the scan may not be necessary because the devices are managed and can be presumed to be up-to-date. Any system, method, or technique known in the art for scanning devices may be used. The device scanner 330 may be implemented using software, hardware, or a combination of both.

The report generator 340 generates a report detailing the results of the network scan at a level of detail selected by an administrator. The report may comprise an analysis of the network scan including the number of devices detected, the number of unmanaged and managed devices, the operating systems installed on the devices and if the operating systems are current with respect to patches and upgrades, the software installed on each device, etc. The administrator may further refine the level of detail provided by the report as desired. Using the report, the administrator may determine the appropriate steps needed to secure the network. Any system, method, or technique known in the art for aggregating collected data into a report may be used. The report generator 340 may be implemented using software, hardware, or a combination of both.

Exemplary Computing Environment

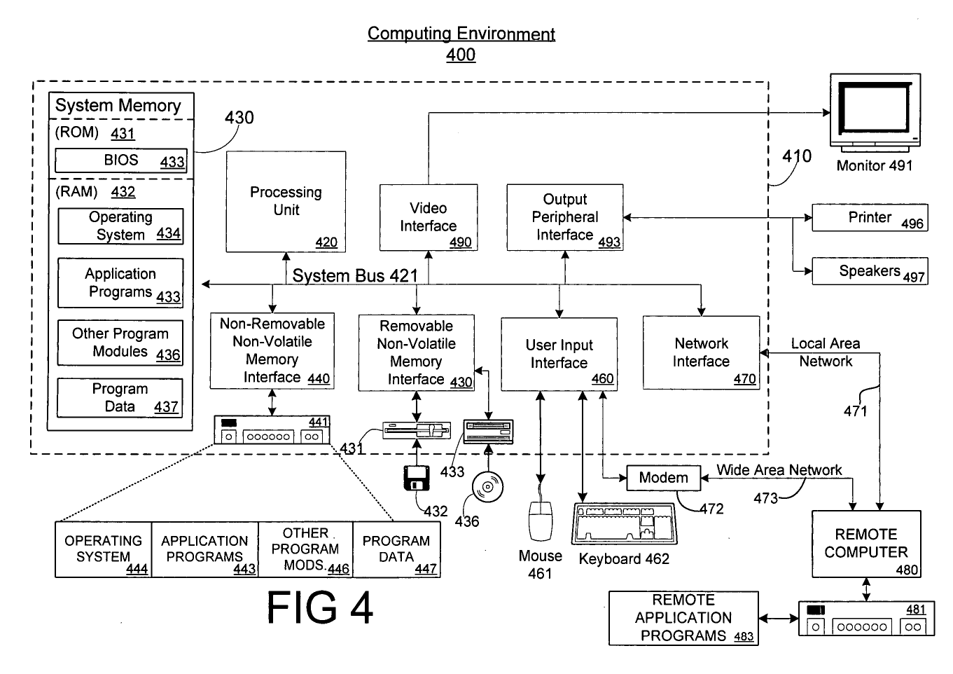

FIG. 4 illustrates an example of a suitable computing system environment 400 in which the invention may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing the invention includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 410 typically includes a variety of computer readable media. Computer readable media can be any available media that can be accessed by computer 410 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or non-volatile memory such as ROM 431 and RAM 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/non-volatile computer storage media. By way of example only, FIG. 4 illustrates a hard disk drive 440 that reads from or writes to non-removable, non-volatile magnetic media, a magnetic disk drive 451 that reads from or writes to a removable, non-volatile magnetic disk 452, and an optical disk drive 455 that reads from or writes to a removable, non-volatile optical disk 456, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted include a LAN 471 and a WAN 473, but may also include other networks. Such networking environments are commonplace in offices, enterprise-wide computer networks, intranets and the internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 483 as residing on memory device 481. It will be appreciated that the network connections shown are exemplary and other means of establishing a communications link between the computers may be used.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A method for scanning a network for managed and unmanaged devices, comprising:
detecting if there are devices at the each of a plurality of IP addresses;
determining, for each of the detected devices, if the device provides administrative access;
determining, for each of devices that provide administrative access, if the device is managed or unmanaged; and
retrieving from each unmanaged device information indicative of the device's operating system and applications.

2. The method of claim 1, further comprising generating a report comprising the retrieved information from each of the unmanaged devices.

3. The method of claim 1, further comprising receiving the plurality of IP addresses.

4. The method of claim 3, wherein the IP addresses are received from an administrator.

5. The method of claim 3, wherein receiving the plurality of IP addresses comprises:
determining the available subnets in the network; and
generating the possible IP addresses belonging to the available subnets.

6. The method of claim 5, wherein determining the available subnets comprises reading an active directory of one of the devices, and retrieving a list of available subnets from the active directory.

7. The method of claim 1, wherein detecting if there are devices at the each of the plurality of IP addresses comprises:
pinging each of the plurality of IP addresses; and
detecting a device if a response is received from the ping.

8. The method of claim 7, wherein the devices are pinged in parallel.

9. The method of claim 1, further comprising retrieving from each managed device information indicative of the device's operating system and applications.

10. A computer-readable medium with computer-executable instructions stored thereon for performing the method of:
generating a plurality of IP addresses;
detecting if there are devices at the each of the generated IP addresses;
determining, for each of the detected devices, if the device provides administrative access;
determining, for each of devices that provide administrative access, if the device is managed or unmanaged; and
retrieving from each unmanaged device information indicative of the device's operating system and applications.

11. The computer-readable medium of claim 10, further comprising computer-executable instructions for generating a report comprising the retrieved information from each of the unmanaged devices.

12. The computer-readable medium of claim 10, wherein generating a plurality of IP addresses comprises computer-executable instructions for:
determining the available subnets in the network; and
generating all possible IP addresses belonging to the available subnets.

13. The computer-readable medium of claim 12, wherein determining the available subnets comprises computer-executable instructions for reading an active directory of one of the devices, and retrieving a list of available subnets from the active directory.

14. The computer-readable medium of claim 10, wherein the IP addresses are provided by an administrator.

15. The computer-readable medium of claim 10, wherein detecting if there are devices at the each of the generated IP addresses comprises computer-executable instructions for:
pinging each of the generated IP addresses; and
detecting a device if a response is received from the ping.

16. The computer-readable medium of claim 15, wherein the devices are pinged in parallel.

17. The computer-readable medium of claim 10, further comprising computer-executable instructions for retrieving from each managed device information indicative of the device's operating system and applications.

18. A system for scanning a network for managed and unmanaged devices, comprising:
a generating component for generating a plurality of IP addresses and detecting if there are devices at the each of the generated IP addresses;
a access detection component for determining which of the detected devices provide administrative access rights; and
a scanning component for scanning the devices that provide administrative access for software and operating system data.

19. The system of claim 18, further comprising a reporting component for generating a report comprising the software and operating system data.

20. The system of claim 18, wherein the generating component generates the plurality of IP addresses by determining the available subnets in the network, and generates all possible IP addresses belonging to the available subnets.
